(19) United States
(12) Patent Application Publication
(10) Pub. No.: US 2008/0304715 A1
(43) Pub. Date: Dec. 11, 2008

(54) INDIVIDUAL-IDENTIFYING COMMUNICATION SYSTEM AND PROGRAM EXECUTED IN INDIVIDUAL-IDENTIFYING COMMUNICATION SYSTEM

(75) Inventor: Mitsuyoshi Ishida, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Corp., Koto-ku (JP)

(21) Appl. No.: 12/115,093

(22) Filed: May 5, 2008

(30) Foreign Application Priority Data
Jun. 7, 2007 (JP) 2007-151963

(51) Int. Cl. G06K 9/00

(52) U.S. Cl. 382/118

(57) ABSTRACT

An individual-identifying communication system of the present invention comprises an imaging device; a display device capable of displaying an image based on image data obtained by said imaging device; a selection device for selecting a predetermined area within the displayed image; a storage device storing plural standard face information data and plural identification information data for specifying a mobile terminal to communicate with, each of the identification information data being associated with each standard face information data; an acquisition device acquiring acquisition face information data from image data; a standard face information data determination device determining the standard face information data corresponding to the acquisition face information data, based on the acquisition face information data acquired from selection area image data and plural standard face information data; and a communication device communicating with a mobile terminal assigned with identification information data corresponding to the standard face information data.

### CROSS-REFERENCE TO RELATED APPLICATIONS

This application claims benefit of priority based on Japanese Patent Application No. 2007-151963 filed on Jun. 7, 2007. The contents of this application are incorporated herein by reference in their entirety.

### BACKGROUND OF THE INVENTION

1. Field of the Invention

The present invention relates to an individual-identifying communication system, and a program executed in an individual-identifying communication system.

2. Discussion of the Background

Conventionally, there has been a system in which an administrator of a facility (e.g., a recreation hall and a concert hall) watches on a monitor a moving image of the interior of the facility captured by a security camera, so as to grasp the existence of a suspicious person, the current position of facility employees, and the like. In such a system, the administrator visually recognizes a facial image of the person displayed to the monitor. Therefore, in the case where the image lacks sharpness or the image is small, visually identifying the person in the image could be difficult.

As a technology capable of solving such a problem, there has been a facial recognition system capturing the face of a moving person such as a pedestrian and then determining from the captured facial image whether or not the person is one of the previously registered people (e.g., see JP-A 2006-236244). Further, technologies for extracting facial features of a specific person out of a plurality of faces in an image have been disclosed (e.g., see JP-A 2006-318352, JP-A 2005-115847, and JP-A 2005-210293). Adopting the above-described facial recognition systems makes it possible to objectively determine whether or not a person in a moving image is one of the previously registered employees, and which of the registered employees the person is.

The contents of JP-A 2006-236244, JP-A 2006-318352, JP-A 2005-115847, and JP-A 2005-210293 are incorporated herein by reference in their entirety.

### SUMMARY OF THE INVENTION

However, when the administrator wishes to contact the employee in the moving image, the administrator must check who the employee is, and find the mobile phone number of the employee to call the employee. Thus, there has been a problem that a considerable waste of time generates between the time when the administrator wishes to contact the employee and the time when the administrator actually contacts the employee. Particularly, when an emergency contact is needed in such a case where the administrator has found a suspicious person and a prompt action is required or the like, for example it might happen that the administrator loses sight of the suspicious person and is not able to apply necessary measures due to the wasted time, causing a major security problem. Although an approach of having the administrator to memorize phone numbers of all the employees is possible, memorizing phone numbers of all the employees is difficult if there are a large number of employees. Further, the administrator might memorize wrong phone numbers.

The present invention was made with attention focused on the above-mentioned problems, and has an object to provide an individual-identifying communication system and a program executed in an individual-identifying communication system which are capable of promptly contacting a person in a captured moving image.

In order to attain the above-mentioned object, the present invention provides the following.

(1) An individual-identifying communication system, comprising:

an imaging device;

a display device capable of displaying an image based on an image data obtained by capturing images using the imaging device;

a selection device for selecting a predetermined area within the image displayed to the display device;

a storage device storing a plurality of standard face information data indicating facial features of a person which differ from person to person and a plurality of identification information data for specifying a mobile terminal to communicate with, each of the identification information data being associated with each of the standard face information data;

an acquisition device acquiring an acquisition face information data indicating facial features of a person, from an image data obtained by capturing images using the imaging device;

a standard face information data determination device determining, based on the acquisition face information data that has been acquired by the acquisition device from a selection area image data indicating an image of the area selected by using the selection device and on the plurality of standard face information data previously stored in the storage device, the standard face information data corresponding to the acquisition face information data; and

a communication device communicating with a mobile terminal assigned with the identification information data associated with the standard face information data determined by the standard face information data determination device.

According to the invention of (1), an image based on image data obtained by the imaging device (e.g., a camera) is displayed to the display device (e.g., a display); and when a predetermined area within the displayed image is selected by the selection device, the acquisition face information data indicating facial features of a person is acquired from selection area image data indicating the image of the area.

Then, based on the acquired acquisition face information data and the plurality of standard face information data stored in the storage device (e.g., a memory), the standard face information data corresponding to the acquired acquisition face information data is determined. The standard face information data indicates facial features of a person, and is associated with the identification information data (e.g., the phone number data of the mobile phone) of the mobile terminal when stored. When the standard face information data corresponding to the acquisition face information data is determined, communication is started with the mobile terminal with which identification information data associated with the determined standard face information data is assigned.

Accordingly, selecting an area within a moving image obtained by capturing images enables, in the case where the captured person within the area is one of the previously registered people, communication with the mobile terminal used by the person. Since only selecting the area including the person to contact to enables communication with the person, it is not required to memorize the names of the registered people and the phone numbers of the mobile terminals or search those in each case, thereby saving the facility administrator the trouble. Further, it becomes possible to take prompt actions even when an emergency contact is required.

Further, the present invention provides the following.

(2) An individual-identifying communication system, comprising:

a plurality of imaging devices;

a voice input device for inputting a voice;

a comparison data acquisition device acquiring, from a voice input from the voice input device, a comparison data based on the voice;

a storage device storing a plurality of standard face information data indicating facial features of a person which differ from person to person, a plurality of identification information data for specifying a mobile terminal to communicate with, and a plurality of reference data different from person to person which are to be compared with the comparison data, each of the identification information data being associated with each of the respective standard face information data, each of the reference data being associated with each of the standard face information data;

a comparison device determining, by comparing the comparison data obtained by the comparison data acquisition device with the plurality of reference data stored in the storage device, the reference data corresponding to the comparison data;

an acquisition device acquiring an acquisition face information data indicating facial features of a person, from an image data obtained by capturing images using the imaging device;

a determination device determining, based on the acquisition face information data acquired by the acquisition device and on the standard face information data corresponding to the reference data determined by the comparison device, the acquisition face information data corresponding to the standard face information data;

a specific display device displaying an image captured by an imaging device having obtained the image data that has acquired the acquisition face information data determined by the determination device, out of the plurality of imaging devices;

a display device capable of displaying an image based on an image data obtained by capturing images using the imaging device;

a selection device for selecting a predetermined area within the image displayed to the display device;

a standard face information data determination device determining, based on the acquisition face information data that has been acquired by the acquisition device from a selection area image data indicating an image of the area selected by using the selection device and on the plurality of standard face information data previously stored in the storage device, the standard face information data corresponding to the acquisition face information data; and

a communication device communicating with a mobile terminal assigned with the identification information data corresponding to the standard face information data determined by the standard face information data determination device.

According to the invention of (2), from a voice (e.g., a voice calling a specific employee) that is input from the voice input device (e.g., a microphone), the comparison data (e.g., voice data) based on the voice is acquired by the comparison data acquisition device (e.g., a voice-recognition software). Then, the acquired comparison data is compared to the reference data different from person to person (e.g., voice data based on the voice when the name of the person is pronounced) so as to determine the reference data corresponding to the comparison data; based on the standard face information data corresponding to the determined reference data and the acquisition face information data acquired from the image data obtained by capturing images, the acquisition face information data corresponding to the standard face information data is determined. The standard face information data indicates facial features of a person, and is stored in association with the respective identification information data of a mobile terminal (e.g., phone number data of a mobile phone) and the respective reference data. An image captured by an imaging device having obtained the image data that has acquired the determined acquisition information data, out of the plurality of imaging devices, is displayed to the specific display device (e.g., a main display).

When a predetermined area within the displayed image is selected by the selection device, the acquisition face information data indicating facial features of a person is acquired from selection area image data indicating the image of the area. Thereafter, based on the acquired acquisition face information data and the plurality of standard face information data stored in the storage device, the standard face information data corresponding to the acquired acquisition face information data is determined. When the standard face information data corresponding to the acquisition information data is determined, communication is started with the mobile terminal with which identification information data associated with the determined standard face information data is assigned.

When a voice is input from the voice input device, an image showing the person corresponding to the comparison data based on the voice is displayed to the specific display device; therefore, it is possible to immediately know where the person is by calling his or her name and the like.

Further, selecting an area within a moving image obtained by capturing images enables, in the case where the captured person within the area is one of the previously registered people, communication with the mobile terminal used by the person. Since only selecting the area including the person to contact to enables communication with the person, it is not required to memorize the names of the registered people and the phone numbers of the mobile terminals or search those in each case, thereby saving the facility administrator the trouble. Further, it becomes possible to take prompt actions even when an emergency contact is required.

Further, the present invention provides the following.

(3) The individual-identifying communication system, according to the above-mentioned (1),

wherein

the selection device is a pointing device.

According to the invention of (3), an area within a moving image is selected using the pointing device (e.g., a mouse in a computer system). Accordingly, it is possible to easily specify a selecting area intuitively by moving a symbol (e.g., a cursor) indicating the current position on the screen.

Further, the present invention provides the following.

(4) The individual-identifying communication system, according to the above-mentioned (1),

wherein

the selection device is a touch panel installed on the front surface of the display device.

According to the invention of (4), an area within a moving image is selected using the touch panel. Accordingly, it is possible to easily specify a selecting area intuitively by touching a predetermined place on the touch panel corresponding to the selection-desired area within the moving image.

Further, the present invention provides the following.

(5) The individual-identifying communication system, according to the above-mentioned (1),

wherein

the mobile terminal is a mobile phone, and the identification information data is a phone number data indicating a phone number of the mobile phone.

According to the invention of (5), when the standard face information data corresponding to the acquisition face information data acquired from the image data in the selected area within the moving image is determined, communication is started with the mobile phone with which the phone number associated with the determined standard face information data is assigned. Accordingly, it is possible to communicate with the person to contact to in the moving image, through the mobile phone.

Further, the present invention provides the following.

(6) A individual-identifying communication system, comprising:

a camera;

a display device capable of displaying an image based on an image data obtained by capturing images using the camera;

an input device for selecting a predetermined area within the image displayed to the display device;

a memory storing a plurality of standard face information data indicating facial features of a person which differ from person to person and a plurality of identification information data for specifying a mobile terminal to communicate with, each of the identification information data being associated with each of the standard face information data;

a communication device capable of communicating with the mobile terminal; and

a controller,

the controller programmed to execute the processing of

(a) capturing images using the camera,

(b) displaying to the display device an image based on an image data obtained in the processing (a),

(c) selecting a predetermined area within the image displayed to the display device, based on an input from the input device,

(d) acquiring an acquisition face information data indicating facial features of a person, from an image data obtained by capturing images using the camera,

(e) determining, based on the acquisition face data acquired from a selection area image data indicating an image of the area selected in the processing (c) and on the plurality of standard face information data previously stored in the memory, the standard face information data corresponding to the acquired acquisition face information data, and

(f) communicating, through the communication device, with a mobile terminal assigned with the identification information data associated with the standard face information data determined in the processing (e).

According to the invention of (6), an image based on image data obtained by the camera is displayed to the display device (for example, a display); and when a predetermined area within the displayed image is selected by the input device (e.g., a mouse in a computer system), the standard face information data corresponding to the acquisition face information data is determined, based on the acquisition face information data acquired from selection area image data indicating the image of the area and on the plurality of standard face information data previously stored in the memory. The standard face information data indicates facial features of a person, and is associated with the identification information data of the mobile terminal used by the person when stored. When the standard face information data corresponding to the acquisition face information data is determined, communication is started with the mobile terminal with which identification information data associated with the determined standard face information data is assigned, through the communication device.

Accordingly, selecting an area within a moving image obtained by capturing images enables, in the case where the captured person within the area is one of the previously registered people, communication with the mobile terminal used by the person. Since only selecting the area including the person to contact to enables communication with the person, it is not required to memorize the names of the registered people and the phone numbers of the mobile terminals or search those in each case, thereby saving the facility administrator the trouble. Further, it becomes possible to take prompt actions even when an emergency contact is required.

Further, the present invention provides the following.

(7) A program executed in an individual-identifying communication system that comprises: a camera; a display device capable of displaying an image based on an image data obtained by capturing images using the camera; an input device for selecting a predetermined area within the image displayed to the display device; a memory storing a plurality of standard face information data indicating facial features of a person which differ from person to person and a plurality of identification information data for specifying a mobile terminal to communicate with, each of the identification information data being associated with each of the standard face information data; and a communication device capable of communicating with the mobile terminal, the program comprising

an image capture step of capturing images using the camera,

a display step of displaying to the display device an image based on an image data obtained using the camera, a selection step of selecting a predetermined area within the image displayed to the display device, based on an input from the input device,

an acquisition step of acquiring an acquisition face information data indicating facial features of a person, from an image data obtained by capturing images using the camera,

a determination step of determining, based on the acquisition face data acquired from a selection area image data indicating an image of the area selected by the input device and on the plurality of standard face information data previously stored in the memory, the standard face information data corresponding to the acquisition face information data, and

a communication step of communicating, through the communication device, with a mobile terminal assigned with the identification information data associated with the standard face information data determined in the determination step.

According to the invention of (7), an image based on image data obtained by the camera is displayed to the display device (for example, a display); and when a predetermined area within the displayed image is selected by the input device (e.g., a mouse in a computer system), the standard face information data corresponding to the acquisition face information data is determined, based on the acquisition face information data acquired from selection area image data indicating the image of the area and on the plurality of standard face information data previously stored in the memory. The standard face information data indicates facial features of a person, and is associated with the identification information data of the mobile terminal used by the person when stored. When the standard face information data corresponding to the acquisition face information data is determined, communication is started with the mobile terminal with which identification information data associated with the determined standard face information data is assigned, through the communication device.

Accordingly, selecting an area within a moving image obtained by capturing images enables, in the case where the captured person within the area is one of the previously registered people, communication with the mobile terminal used by the person. Since only selecting the area including the person to contact to enables communication with the person, it is not required to memorize the names of the registered people and the phone numbers of the mobile terminals or search those in each case, thereby saving the facility administrator the trouble. Further, it becomes possible to take prompt actions even when an emergency contact is required.

According to the present invention, it is possible to promptly contact a person in a moving image obtained by capturing images.

### BRIEF DESCRIPTION OF THE DRAWINGS

FIG. 1 is a diagrammatic view showing an entire configuration of an individual-identifying communication system according to one embodiment of the present invention.

FIG. 2 is a block diagram showing an internal configuration of the computer shown in FIG. 1.

FIG. 3 is a block diagram showing an internal configuration of the telephone shown in FIG. 1.

FIG. 4 is a block diagram showing an internal configuration of the camera shown in FIG. 1.

FIG. 5 is a block diagram showing an internal configuration of the mobile phone shown in FIG. 1.

FIG. 6 is a view showing one example of a standard face information data table.

FIG. 7 is a view showing one example of an image displayed to a display provided in the computer.

FIG. 8 is a view showing one example of an image displayed to the display provided in the computer.

FIG. 9 is a view showing one example of an image displayed to a display provided in a computer.

FIG. 10 is a flowchart showing a subroutine of processing of executing individual-identifying communication in a computer.

### DESCRIPTION OF THE EMBODIMENTS

The individual-identifying communication system of the present invention will be described with reference to the drawings.

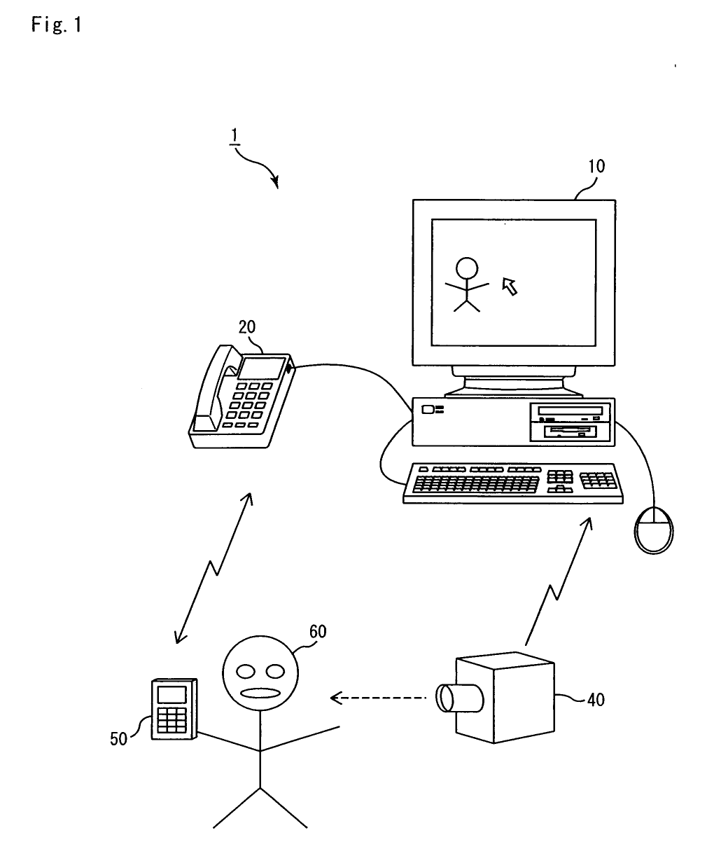

FIG. 1 is a diagrammatic view showing an entire configuration of an individual-identifying communication system according to one embodiment of the present invention.

As shown in FIG. 1, an individual-identifying communication system 1 is provided with a computer 10, a telephone 20 connected to the computer 10 so as to be capable of transmitting data thereto and receiving data therefrom, a camera 40 installed in a facility, and a mobile phone 50 owned by a person 60.

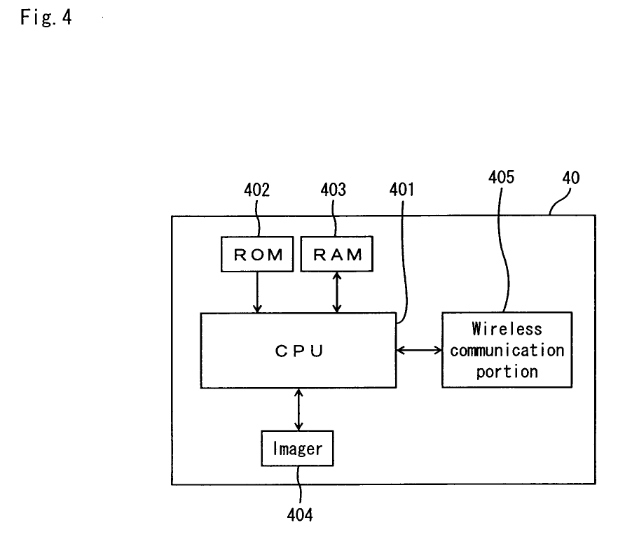

The camera 40 is installed at a predetermined location inside the facility and captures images of a person and the like in the facility. The camera 40 is provided with a zoom function and is vertically and horizontally movable within 100 degrees in each direction. The camera 40 corresponds to the imaging device in the present invention. Image data obtained by capturing images using the camera 40 is transmitted to the computer 10 through a wireless communication portion 405 (see FIG. 4) provided in the camera 40.

It is to be noted that an image captured by the camera 40 is a moving image in the present embodiment.

Further, in the present invention, a facility to have the imaging device installed therein is not particularly limited; examples of the facility include a recreation facility such as a pachinko parlor, a concert hall, a department store and an office building.

Furthermore, although in the present embodiment a case is described where the camera 40 is installed in a facility, the location for installing the imaging device is not limited in the present invention. For example, a configuration may be adopted in which the imaging device is installed outdoors in an urban area or the like so that a specific area is monitored.

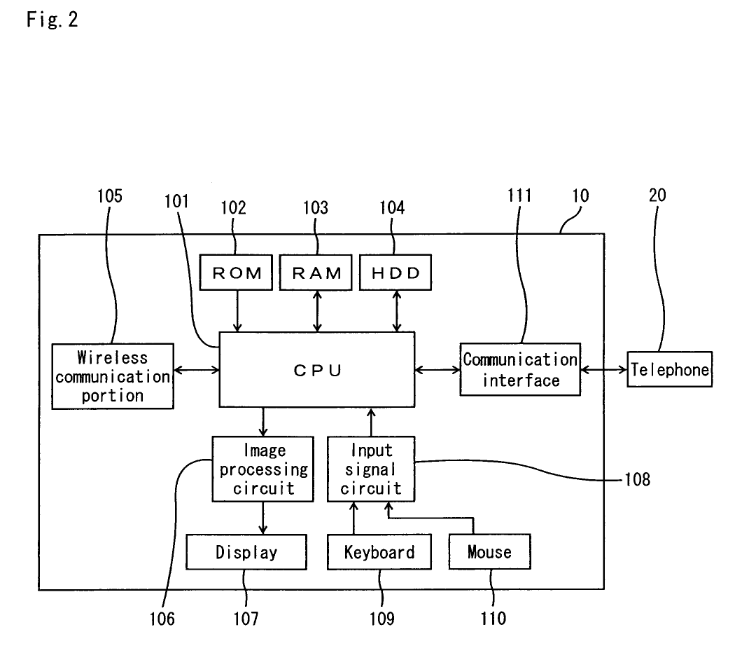

The computer 10 displays to a display 107 (see FIG. 2) an image based on image data received from the camera 40. When an area within the captured moving image is selected by an input from a mouse 110 (see FIG. 2), the computer 10 transmits to the camera 40 a signal commanding to zoom in. The camera 40 captures the enlarged image of the place in the facility corresponding to the selected area. The computer 10 temporarily stores as a still image the image captured by zooming in. The computer 10 detects a facial image of the captured person from the still image, and conducts identification on the detected facial image. Then, when determining that the person is one of the previously registered employees of the facility, the computer 10 transmits to the telephone 20 a command signal indicating a command to dial the phone number of the mobile phone 50 owned by this employee.

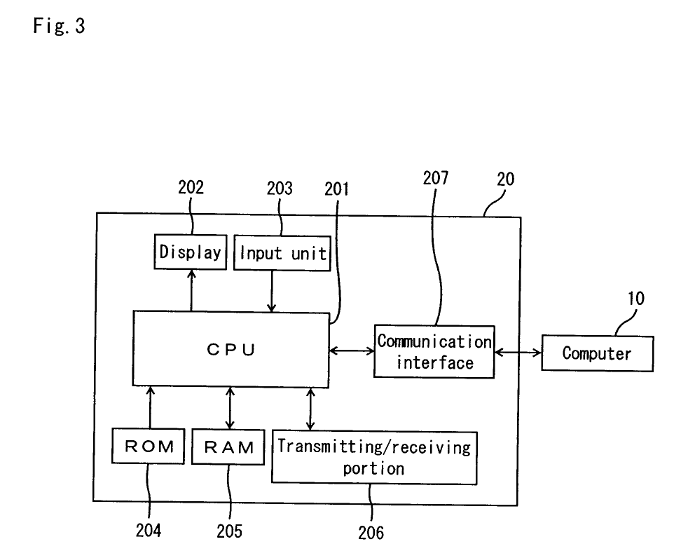

Upon receipt of the command signal from the computer 10, the telephone 20 dials the phone number of the mobile phone 50 of the employee to start communication. The telephone 20 corresponds to the communication device in the present invention. The administrator of the facility visually monitoring the images displayed to the display 107 of the computer 10 can converse with the employee via a transmitting/receiving portion 206 (see FIG. 3) of the telephone 20.

FIG. 2 is a block diagram showing an internal configuration of the computer shown in FIG. 1.

As shown in FIG. 2, the computer 10 is provided with a CPU 101; to the CPU 101, there are connected a ROM 102, a RAM 103, an HDD (hard disk drive) 104, a wireless communication portion 105, an image processing circuit 106, an input signal circuit 108, and a communication interface 111.

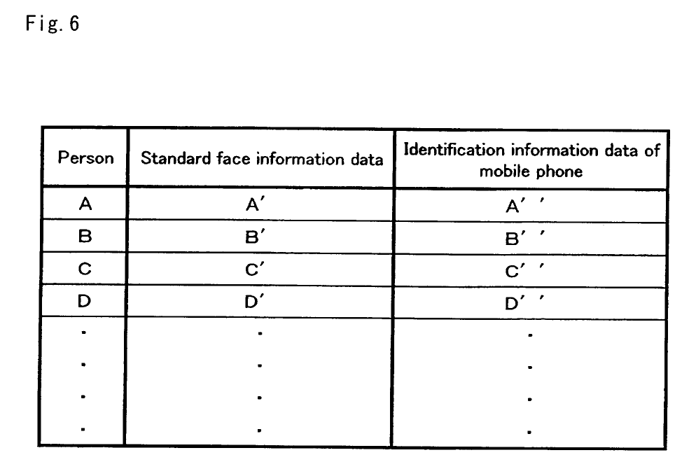

The ROM 102 stores: various types of programs for conducting processing necessary in control of the computer 10; a data table; and the like. The data table includes a standard face information data table to be referred to in facial recognition. The details of the standard face information data table will be described later by using FIG. 6. The ROM 102 corresponds to the storage device of the present invention. The RAM 103 is a memory for temporarily storing various types of data calculated in the CPU 101, and the HDD 104 is an auxiliary storage device for permanently storing the various types of data calculated in the CPU 101.

The wireless communication portion 105 is for transmitting and receiving data between the CPU 101 and the camera 40. The image processing circuit 106 is connected with the display 107 to which an image based on the image data received from the camera 40 through the wireless communication portion 105 is displayed. The display 107 corresponds to the display device in the present invention. Further, a keyboard 109 and a mouse 110 are connected to the input signal circuit 108. Operation of the keyboard 109 or the mouse 110 allows an input of various types of commands. The mouse 110 corresponds to the selection device in the present invention.

To the communication interface 111, the telephone 20 is connected. The computer 10 can transmit a command signal to the telephone 20 through the communication interface 111.

FIG. 3 is a block diagram showing an internal configuration of the telephone shown in FIG. 1.

The telephone 20 according to the present embodiment is capable of connecting to the computer 10 through a communication line; the telephone 20 is configured to start dialing, upon receipt of a signal commanding to dial and of phone number data of the call destination from the computer 10, through the communication line, based on the signal and the phone number data.

As shown in FIG. 3, the telephone 20 includes a CPU 201 to which the computer 10 is connected through a communication interface 207.

Further, the CPU 201 is connected with a ROM 204, a RAM 205, the transmitting/receiving portion 206 used for conversation, a display 202 for conducting various types of display, and an input unit 203 used when phone numbers and the like are manually input.

FIG. 4 is a block diagram showing an internal configuration of the camera shown in FIG. 1.

As shown in FIG. 4, to the CPU 401 included in the camera 40, there are connected a ROM 402, a RAM 403, an imager 404, and a wireless communication portion 405.

The imager 404 is provided with a lens, a CCD (Charge Coupled Device) and the like, and generates an image.

The wireless communication portion 405 is for transmitting and receiving data between the CPU 401 and the computer 10. The CPU 401 transmits image data indicating an image generated by the imager 404 to the computer 10, through the wireless communication portion 405.

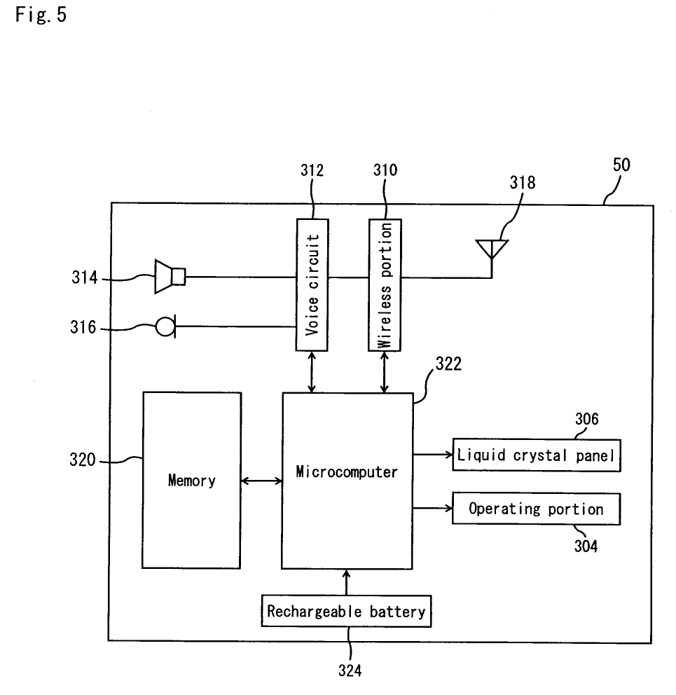

FIG. 5 is a block diagram showing an internal configuration of the mobile phone shown in FIG. 1.

The mobile phone 50 includes an operating portion 304, a liquid crystal panel 306, a wireless portion 310, a voice circuit 312, a speaker 314, a microphone 316, a transmitting/receiving antenna 318, a nonvolatile memory 320, a microcomputer 322, and a rechargeable battery 324.

The wireless portion 310 is controlled by the microcomputer 322 so as to transmit and receive a signal on the airwaves to and from a base station, through the transmitting/receiving antenna 318. The voice circuit 312 outputs to the wireless portion 310 a voice signal output from the microphone 316, as a transmission signal, through the microcomputer 322, in addition to outputting to the speaker 314 a reception signal output from the wireless portion 310 through the microcomputer 322.

The speaker 314 converts the reception signal output from the voice circuit 312 into a reception voice to output it; the microphone 316 converts a transmission voice given from the operator into a voice signal so as to output it to the voice circuit 312.

The non-volatile memory 320 stores, for example, various types of data such as image data for wallpapers and music data for ringtones, and various types of programs, in a non-volatile manner.

The rechargeable battery 324 supplies power to each of the circuits. The microcomputer 322 is comprised of a CPU, a ROM, and a RAM, and conducts, for example, calling/receiving processing, e-mail creating and sending/receiving processing, Internet processing and the like.

The mobile phone 50 corresponds to the mobile terminal in the present invention.

Next, the standard face information data table to be referred to in execution of facial recognition of a person whose image is captured by the individual-identifying communication system 1 is described. The standard face information data table is the data table stored in the ROM 102 of the computer 10.

FIG. 6 is a view showing an example of a standard face information data table.

In the standard face information data table, with the name of each of the plurality of registered people (facility employees), the standard face information data of each person and the identification information data (phone number data) of the mobile phone 50 owned by each person are associated. For example, in the standard face information data table shown in FIG. 6, the standard face information data of the person named A is A′, and the identification information data of the mobile phone 50 of A is A″.

The standard face information data indicates facial features of a registered person and includes data on feature points (e.g., a point indicating each end of the mouth) of the face.

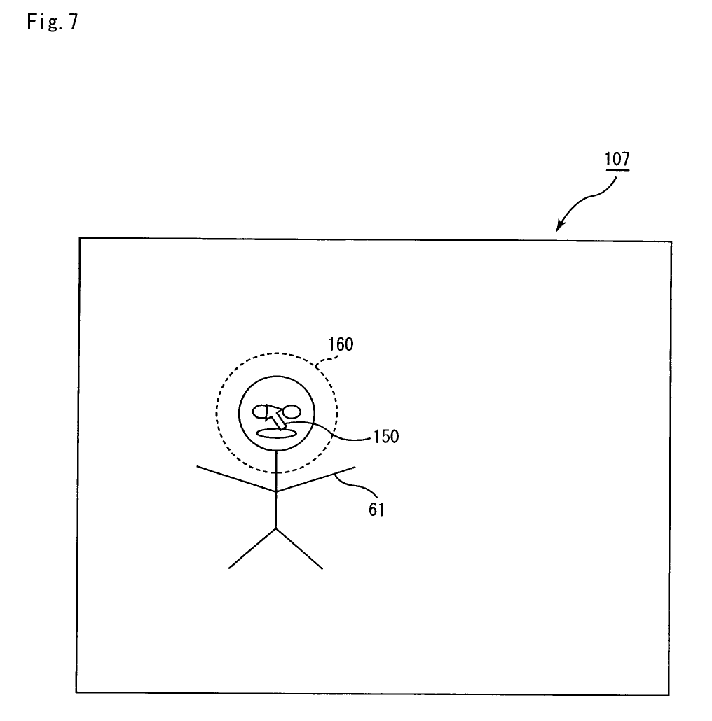

Next, a flow of facial recognition conducted in the individual-identifying communication system 1 will be described based on FIGS. 7 to 9.

FIGS. 7 to 9 are views showing an example of an image displayed to a display provided in a computer.

FIG. 7 is an example of an image displayed to the display 107 when an area including the facial image of the person in the image is selected.

As shown in FIG. 7, a portion corresponding to the substantial center of the face in the image 61 indicating a person is selected with a cursor 150 by using the mouse 110. A dashed circle 160 in the figure shows a circle with radius 80 pixels to be displayed taking the position of the cursor 150 as its center, when the mouse 110 is clicked; the portion surrounded by the dashed circle 160 shows the selected area (hereinafter, also referred to as a selection area). The image data showing the selection area corresponds to the selection area image data in the present invention.

It is to be noted that a configuration may be adopted in which, for example, the person selecting an area can specify a selection range as desired by drag-and-drop.

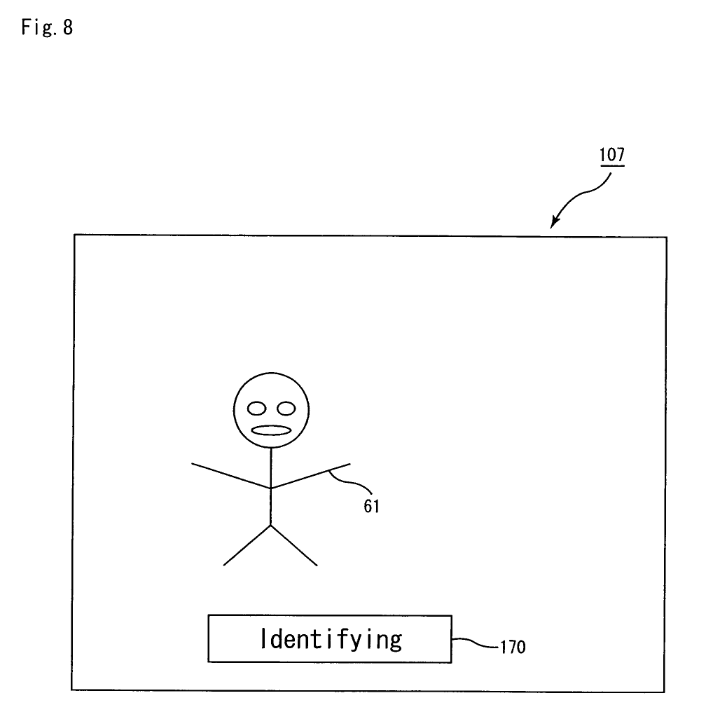

FIG. 8 is an example of an image displayed to the display 107 in facial recognition.

The computer 10 transmits to the camera 40 a signal commanding to zoom in when the area is selected with the mouse 110. The camera 40 captures an enlarged view of the place within the facility corresponding to the selected area. The computer 10 temporarily stores as a still image the image captured by zooming in. Then the computer 10 detects the facial image from the stored still image. The detection of the facial image is conducted by detecting the lines of the face by edge extraction. Upon detection of the facial image, the computer 10 extracts facial image data indicating the detected facial image out of the selection area image data indicating the image of the selected area, and then acquires acquisition face information data indicating the facial features of the person, out of the facial image data. The acquisition face information data includes data on the facial features (e.g., a point indicating each end of the mouth).

The computer 10 then refers to the standard face information data table stored in the ROM 102, and determines the standard face information data corresponding, within a predetermined error range, to the acquired acquisition face information data.

When the above-mentioned processing is executed, an identification-time image 170 showing “Identifying” which indicates execution of facial recognition is displayed to the display 107, as shown in FIG. 8.

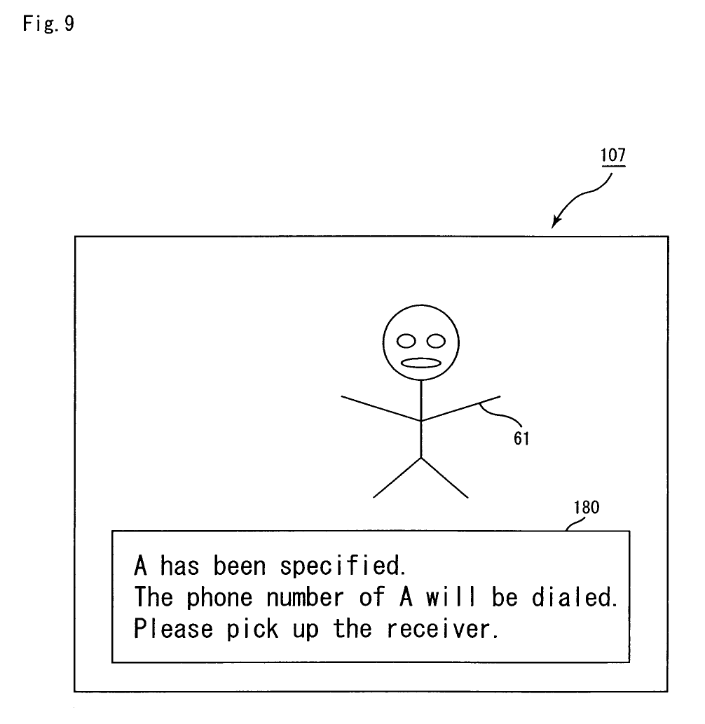

FIG. 9 is an example of an image displayed to the display 107 when the standard face information data corresponding to the acquisition face information data is determined.

Upon determination of the standard face information data, the computer 10 transmits to the telephone 20 a command signal indicating a command to dial the phone number of the mobile phone 50 assigned with the identification information data corresponding to the determined standard face information data, according to the corresponding relations in the standard face information data table. Namely, the computer 10 transmits to the telephone 20 a command signal indicating a command to dial the phone number of the mobile phone 50 used by the person corresponding to the determined standard face information data.

FIG. 9 shows an image displayed to the display 107 when it is determined that the standard face information data corresponding to the acquisition face information data is A′ (see FIG. 6). The person corresponding to the standard face information data A′ is A, as shown in FIG. 6, and an identification result image 180 indicating that the phone number of A will be dialed is displayed to the display 107, as shown in FIG. 9.

Since the identification information data of the mobile phone 50 corresponding to the standard face information data A′ is A″, the computer 10 transmits to the telephone 20 a command signal commanding to dial the phone number of the mobile phone 50 used by the person A, based on the identification information data A″.

The person viewing the display 107 is enabled to converse with the person A, through the transmitting/receiving portion 206 of the telephone 20.

Next, processing executed in the computer 10 is described.

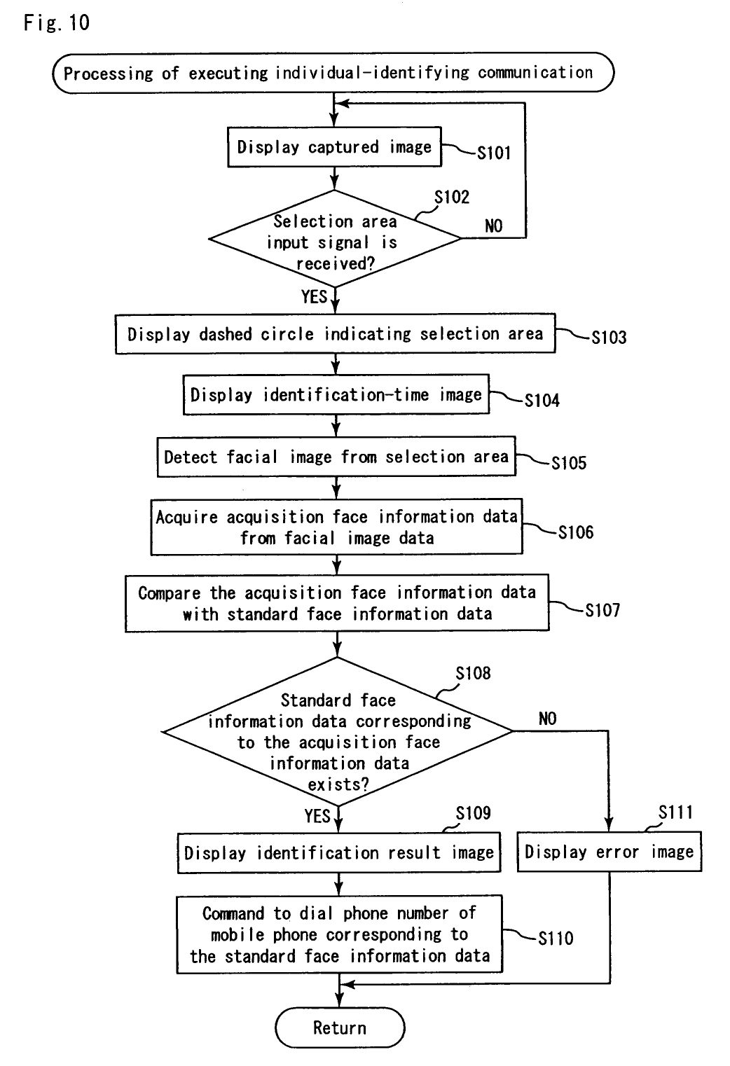

FIG. 10 is a flowchart showing a subroutine of processing of executing individual-identifying communication in the computer 10.

First, the CPU 101 provided in the computer 10 receives image data obtained by capturing images using the camera 40, through the wireless communication portion 105, and displays an image based on the received image data (step S101).

Next, the CPU 101 determines in step S102 whether or not a selection area input signal indicating that an area within the image is selected (clicked) with the mouse 110 is received from the input signal circuit 108.

When determining that the selection area input signal is not received, the CPU 101 returns the processing to step S101.

On the other hand, when determining that the selection area input signal is received, the CPU 101 displays the dashed circle 160 indicating the selection area to the display 107, in step S103 (see FIG. 7).

Next, in step S104, the CPU 101 displays the identification-time image 170 to the display 107 (see FIG. 8).

The CPU 101 then transmits to the camera 40 a signal commanding to zoom in. Upon receipt of the signal, the camera 40 captures an enlarged image of the place within the facility corresponding to the selection area (the portion surrounded by the dashed circle 160) after adjusting the capture angle within the above-described movable range.

The CPU 101 stores as a still image the obtained zoomed-in image, into the RAM 103. Then, the CPU 101 detects the facial image indicating the face of the person from the stored still image (step S105). Specifically, the CPU 101 conducts an edge extraction with the use of Laplacian filter, so as to detect the portion corresponding to the face line. Then, the CPU 101 recognizes as the facial image the image of the portion surrounded by the face line.

Next in step S106, the CPU 101 acquires the acquisition face information data indicating the facial features, from the facial image data indicating the facial image detected in step S105. When executing the processing of step S106, the CPU 101 functions as the acquisition device in the present invention.

In step S107, the CPU 101 compares the acquisition face information data acquired in step S106 with the standard face information data included in the standard face information data table stored in the ROM 102. Specifically, the CPU 101 determines whether or not the information indicated by the respective data (data on the facial features) constituting the acquisition face information data matches, within a predetermined error range, the information indicated by the respective data constituting the standard face information data. When executing the processing of step S107, the CPU 101 functions as the standard face information data determination device in the present invention.

Next, in step S108, the CPU 101 determines whether or not the standard face information data corresponding to the acquisition face information data exists. Namely, the CPU 101 determines whether or not the standard face information data that matches, within the predetermined error range, the acquisition face information data exists.

When determining that the standard face information data corresponding to the acquisition face information data does not exist, the CPU 101 displays an error image saying “the specified person has not been registered” to the display 107 (step S111).

On the other hand, when determining that the standard face information data corresponding to the acquisition face information data exists, the CPU 101 displays the identification result image 180 to the display 107, in step S109 (see FIG. 9).

In step S110, the CPU 101 transmits, to the telephone 20, the identification information data (phone number data) corresponding to the standard face information data determined to match within the predetermined error range the acquisition face information data, and a command signal indicating a command to dial the phone number of the mobile phone 50 (the mobile phone 50 owned by the person corresponding to the standard face information data) assigned with the identification information data.

Upon receipt of the phone number data and the command signal, the telephone 20 identifies the phone number based on the phone number data. Then, after detecting that a receiver (the transmitting/receiving portion 206) has been picked up or that an input selecting a handsfree function has been entered from the input unit 203, the telephone 20 dials the identified phone number.

After executing the processing of step S110 or step S111, the CPU 101 terminates the present subroutine.

As described above, the individual-identifying communication system 1 according to the present embodiment comprises: the camera 40 (the imaging device); the display 107 (the display device) capable of displaying an image based on an image data obtained by capturing images using the camera 40; the mouse 110 (the selection device) for selecting a predetermined area within the image displayed to the display 107; the ROM 102 (the storage device) storing a plurality of standard face information data indicating facial features of a person which differ from person to person and a plurality of identification information data for specifying a mobile phone 50 (mobile terminal) to communicate with, each of the identification information data being associated with each of the standard face information data; the CPU 101 (the acquisition device and the standard face information data determination device) acquiring an acquisition face information data indicating facial features of a person, from an image data obtained by capturing images using the camera 40, and then determining, based on the acquisition face information data that has been acquired from a selection area image data indicating an image of the area selected by using the mouse 110 and on the plurality of standard face information data previously stored in the ROM 102, the standard face information data corresponding to the acquisition face information data; and the telephone 20 communicating with the mobile phone 50 assigned with the identification information data associated with the standard face information data determined.

According to the individual-identifying communication system 1, an image based on image data obtained by the camera 40 is displayed to the display 107; and when a predetermined area within the displayed image is selected by the mouse 110, the acquisition face information data indicating facial features of a person is acquired from selection area image data indicating the image of the area. Then, based on the acquired acquisition face information data and the plurality of standard face information data stored in the ROM 102, the standard face information data corresponding to the acquired acquisition face information data is determined. Then, communication is started with the mobile phone 50 with which identification information data associated with the determined standard face information data is assigned.

Accordingly, selecting an area within a moving image obtained by capturing images enables, in the case where the captured person within the area is one of the previously registered people, communication with the mobile phone 50 used by the person. Since only selecting the area including the person to contact to enables communication with the person, it is not required to memorize the names of the registered people and the phone numbers of the mobile phone 50 or search those in each case, thereby saving the facility administrator the trouble. Further, it becomes possible to take prompt actions even when an emergency contact is required.

In the present embodiment, a case has been described in which the telephone 20 is connected to the computer 10 through a communication line, and a call is made by transmission of a command signal from the computer 10 to the telephone 20. Namely, a case has been described in which the communication device in the present invention is the telephone 20, and the communication device is connected to the computer through a communication line. However, the communication device in the present invention is not limited to this example. For example, a computer with a telephone function (a so-called computer phone), which has a handset and a headset, may be used. In this case, a configuration can be adopted in which facial recognition processing and processing of making a phone call to a specified person are executed in a single computer.

Further, in the present embodiment, a case has been described in which an area within an image displayed to the display 107 is selected by the mouse 110. Namely, a case has been described in which the selection device in the present invention is a mouse (a pointing device). However, the selection device in the present invention is not limited to a pointing device. For example, the selection device may be a touch panel installed on the front surface of a display (display device). When a touch panel is used as the selection device, it is possible to easily specify a selecting area intuitively by touching a predetermined place on the touch panel corresponding to the selection-desired area within the image.

Furthermore, in the present embodiment, a case has been described in which the mobile phone 50 is used as the mobile terminal. However, the mobile terminal in the present invention is not limited to a mobile phone; for example, it may be a wireless communication instrument. In the case of using a wireless communication instrument as the mobile terminal, data indicating a frequency unique to the wireless communication instrument and the standard face information data of the person using the wireless communication instrument should be stored in association with one another.

Moreover, in the present invention, when images of a plurality of areas are captured by a plurality of imaging devices, a configuration is possible to be adopted in which a voice input of the name and the like of a person to contact to of the contact target leads to identification of the person by voice recognition; then, the image capturing the person is determined by facial recognition to be displayed to a main display or the like. Specifically, a configuration described below should be adopted.

Namely, the comparison data acquisition device (e.g., a voice-recognition software) acquires comparison data (e.g., voice data) based on a voice (e.g., voice calling a specific employee) that is input from the voice input device (e.g., a microphone). Then, the acquired comparison data is compared with reference data different from person to person (e.g., voice data based on the voice when the name of the person is pronounced) so as to determine the reference data corresponding to the comparison data; based on standard face information data corresponding to the determined reference data and the acquisition face information data acquired from image data obtained by capturing images, the acquisition face information data corresponding to the standard face information data is determined. An image captured by an imaging device having obtained the image data that has acquired the determined acquisition information data, out of the plurality of imaging devices, is then displayed to the specific display device (e.g., a main display).

From an image displayed to the specific display device, it is possible to specify the person and contact him or her by the procedure shown in the above-described embodiment.

According to the configuration described above, when a voice is input from the voice input device, an image showing the person associated with the reference data based on the voice is displayed to the specific display device; therefore, it is possible to immediately know where the person is by calling his or her name and the like.

It is to be noted that, in regard to facial recognition technology, a technology identifying a moving person is disclosed in JP-A 2006-236244 and so on. Further, a technology extracting the facial features of a specific person out of a plurality of faces of persons in an image is disclosed in JP-A 2006-318352, JP-A 2005-115847, JP-A 2005-210293 and so on. Furthermore, the technology of extracting the facial features is disclosed in JP-B 2973676, JP-A 10-283472 and so on.

Although the present invention has been described with reference to embodiments thereof, these embodiments merely illustrate specific examples, not restrict the present invention. The specific structures of respective means and the like can be designed and changed as required. Furthermore, there have been merely described the most preferable effects of the present invention, in the embodiments of the present invention. The effects of the present invention are not limited to those described in the embodiments of the present invention.

What is claimed as new and desired to be secured by Letters Patent of the United States is:

1. An individual-identifying communication system comprising:
an imaging device;
a display device capable of displaying an image based on an image data obtained by capturing images using said imaging device;
a selection device for selecting a predetermined area within the image displayed to said display device;
a storage device storing a plurality of standard face information data indicating facial features of a person which differ from person to person and a plurality of identification information data for specifying a mobile terminal to communicate with, each of the identification information data being associated with each of the standard face information data;
an acquisition device acquiring an acquisition face information data indicating facial features of a person, from an image data obtained by capturing images using said imaging device;
a standard face information data determination device determining, based on the acquisition face information data that has been acquired by said acquisition device from a selection area image data indicating an image of the area selected by using said selection device and on the plurality of standard face information data previously stored in said storage device, the standard face information data corresponding to the acquisition face information data; and
a communication device communicating with a mobile terminal assigned with the identification information data associated with the standard face information data determined by said standard face information data determination device.

2. An individual-identifying communication system comprising:
a plurality of imaging devices;
a voice input device for inputting a voice;
a comparison data acquisition device acquiring, from a voice input from said voice input device, a comparison data based on the voice;
a storage device storing a plurality of standard face information data indicating facial features of a person which differ from person to person, a plurality of identification information data for specifying a mobile terminal to communicate with, and a plurality of reference data different from person to person which are to be compared with said comparison data, each of the identification information data being associated with each of the respective standard face information data, each of the reference data being associated with each of the standard face information data;
a comparison device determining, by comparing the comparison data obtained by said comparison data acquisition device with the plurality of reference data stored in said storage device, the reference data corresponding to the comparison data;
an acquisition device acquiring an acquisition face information data indicating facial features of a person, from an image data obtained by capturing images using said imaging device;
a determination device determining, based on the acquisition face information data acquired by said acquisition device and on the standard face information data corresponding to the reference data determined by said comparison device, the acquisition face information data corresponding to the standard face information data;
a specific display device displaying an image captured by an imaging device having obtained the image data that has acquired the acquisition face information data determined by said determination device, out of said plurality of imaging devices;
a display device capable of displaying an image based on an image data obtained by capturing images using said imaging device;
a selection device for selecting a predetermined area within the image displayed to said display device;
a standard face information data determination device determining, based on the acquisition face information data that has been acquired by said acquisition device from a selection area image data indicating an image of the area selected by using said selection device and on the plurality of standard face information data previously stored in said storage device, the standard face information data corresponding to the acquisition face information data; and
a communication device communicating with a mobile terminal assigned with the identification information data corresponding to the standard face information data determined by said standard face information data determination device.

3. The individual-identifying communication system according to claim 1,
wherein
said selection device is a pointing device.

4. The individual-identifying communication system according to claim 1,
wherein
said selection device is a touch panel installed on the front surface of said display device.

5. The individual-identifying communication system according to claim 1,
wherein
said mobile terminal is a mobile phone, and said identification information data is a phone number data indicating a phone number of said mobile phone.

6. An individual-identifying communication system comprising:
a camera;
a display device capable of displaying an image based on an image data obtained by capturing images using said camera;
an input device for selecting a predetermined area within the image displayed to said display device;
a memory storing a plurality of standard face information data indicating facial features of a person which differ from person to person and a plurality of identification information data for specifying a mobile terminal to communicate with, each of the identification information data being associated with each of the standard face information data;
a communication device capable of communicating with said mobile terminal; and
a controller,
said controller programmed to execute the processing of
(a) capturing images using said camera,
(b) displaying to said display device an image based on an image data obtained in said processing (a),
(c) selecting a predetermined area within the image displayed to said display device, based on an input from said input device,
(d) acquiring an acquisition face information data indicating facial features of a person, from an image data obtained by capturing images using said camera,
(e) determining, based on the acquisition face data acquired from a selection area image data indicating an image of the area selected in said processing (c) and on the plurality of standard face information data previously stored in said memory, the standard face information data corresponding to the acquired acquisition face information data, and
(f) communicating, through said communication device, with a mobile terminal assigned with the identification information data associated with the standard face information data determined in said processing (e).

7. A program executed in an individual-identifying communication system that comprises: a camera; a display device capable of displaying an image based on an image data obtained by capturing images using said camera; an input device for selecting a predetermined area within the image displayed to said display device; a memory storing a plurality of standard face information data indicating facial features of a person which differ from person to person and a plurality of identification information data for specifying a mobile terminal to communicate with, each of the identification information data being associated with each of the standard face information data; and a communication device capable of communicating with said mobile terminal, said program comprising
an image capture step of capturing images using said camera,
a display step of displaying to said display device an image based on an image data obtained using said camera,
a selection step of selecting a predetermined area within the image displayed to said display device, based on an input from said input device,
an acquisition step of acquiring an acquisition face information data indicating facial features of a person, from an image data obtained by capturing images using said camera,
a determination step of determining, based on the acquisition face data acquired from a selection area image data indicating an image of the area selected by said input device and on the plurality of standard face information data previously stored in said memory, the standard face information data corresponding to the acquisition face information data, and
a communication step of communicating, through said communication device, with a mobile terminal assigned with the identification information data associated with the standard face information data determined in said determination step.
